(19) United States
(12) Patent Application Publication
(10) Pub. No.: US 2011/0062120 A1
(43) Pub. Date: Mar. 17, 2011

(54) Device for welding using a process chamber and welding method

(76) Inventors: Bernd Burbaum, Ubach-Palenberg (DE); Selim Mokadem, Dusseldorf (DE); Norbert Pirch, Aachen (DE)

(21) Appl. No.: 12/934,332

(22) PCT Filed: Feb. 2, 2009
(86) PCT No.: PCT/EP2009/051113

§ 371 Date: Sep. 24, 2010

(30) Foreign Application Priority Data
Mar. 27, 2008 (DE) 10 2008 015 913.1

(51) Int. Cl. B23K 9/18; B23K 26/12

(52) U.S. Cl. 219/74; 219/121.63; 219/121.64

(57) ABSTRACT

A device and a method for welding a component are provided. The component is arranged and welded in a chamber. A welding appliance is provided, the welding appliance being arranged outside the chamber.

### CROSS REFERENCE TO RELATED APPLICATIONS

This application is the US National Stage of International Application No. PCT/EP2009/051113 filed Feb. 2, 2009, and claims the benefit thereof. The International Application claims the benefits of German Application No. 10 2008 015 913.1 DE filed Mar. 27, 2008. All of the applications are incorporated by reference herein in their entirety.

### FIELD OF INVENTION

The invention relates to a welding device having a process chamber and to a welding process in a process chamber.

### BACKGROUND OF INVENTION

Welding processes are used in order to join components to one another or in order to repair components by remelting cracks, in which case material (weld metal) is also added, depending on the requirement, in order to apply material.

In this case, an energy beam, for example a laser beam, is guided over the surface of a component around which a process gas flushes in order to avoid oxidation of the hot (molten) welding material.

However, the protective effect of the process gas is not always sufficient.

### SUMMARY OF INVENTION

It is an object of the invention to overcome the problem mentioned above and to provide a welding device and a welding method.

The object is achieved by a device and by a process as claimed in the independent claims, wherein the component to be welded is arranged in a process chamber and processed therein.

The dependent claims list further advantageous measures which can be combined with one another, as desired, in order to obtain further advantages.

### BRIEF DESCRIPTION OF THE DRAWINGS

FIGS. 1, 2 show welding devices,

FIG. 3 shows a gas turbine,

FIG. 4 shows a perspective view of a turbine blade or vane,

FIG. 5 shows a perspective view of a combustion chamber, and

FIG. 6 shows a list of superalloys.

The figures and the description show only exemplary embodiments of the invention.

### DETAILED DESCRIPTION OF INVENTION

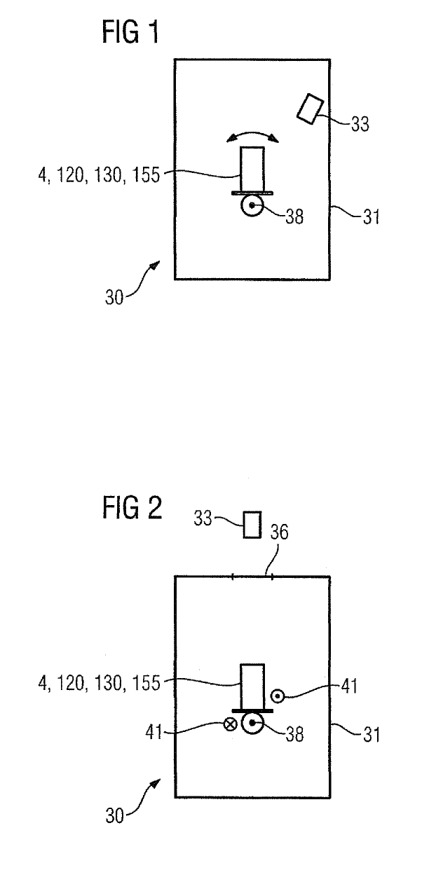

FIG. 1 shows a device 30 with a process chamber 31, which preferably represents a vacuum chamber and/or which has been or is being flooded with a protective gas, e.g. argon (Ar) and/or nitrogen (N₂), or a process gas.

The process chamber 31 preferably has a movement means 38, by means of which a component 4, 120, 130, 155 arranged on the movement means 38 can be tilted and/or can be rotated about the longitudinal axis. With preference, the movement means 38 has to be able to tilt the component 4 away from or toward at least a welding appliance 33. The tilting can be effected as two weld seams are being created, in particular when the variation in curvature of the weld seams to be created changes. A welding process can be considered to be the production of one or more weld seams.

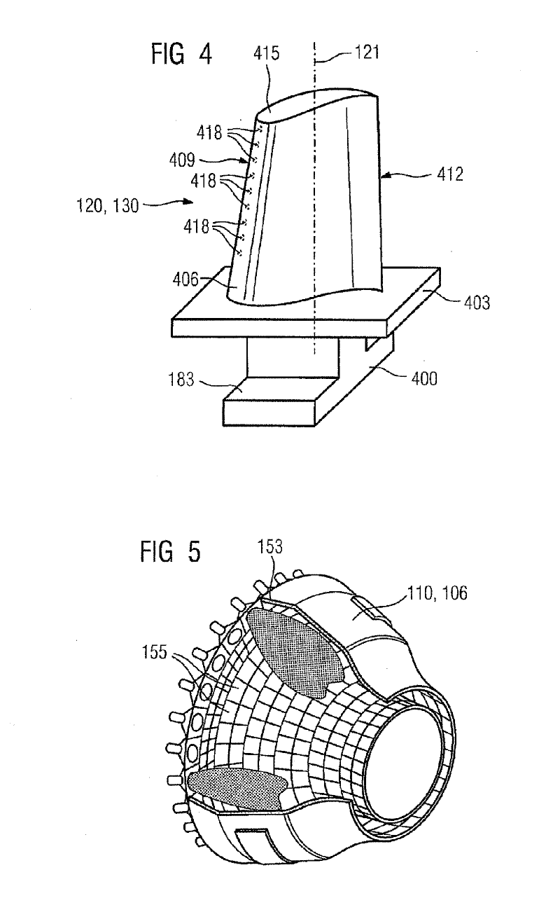

Rotation preferably takes place about an axis which is perpendicular to the longitudinal axis 121 (FIG. 4) of the component 4. The longitudinal axis is most likely parallel to the direction of the beam from the welding appliance 33 or the laser beams or the longitudinal direction of the process chamber 31.

The component 4 can be tilted as it is being processed by means of the welding appliance 33 or only in advance of the irradiation by means of the welding appliance 33. It is therefore possible to take into account a curvature of the surface to be welded.

The component 4, 120, 130, 155 can likewise be displaced vertically by the movement means 38 within the process chamber 31. The process chamber 31 can thus be adapted to various sizes of components 120, 130, 155 and/or to various vertical positions of the component 120, 130, 155 to be welded.

The welding appliance 33 is preferably a laser.

There is preferably a heating loop 41 around the component 4, 120, 130, 155 in order to preheat the component 4, 120, 130, 155 to a specific temperature or in order to produce a temperature gradient for directional solidification of a molten pool, which is generated by the welding appliance 33. This produces a local increase in temperature. The preheating temperature is likewise preferably measured and regulated.

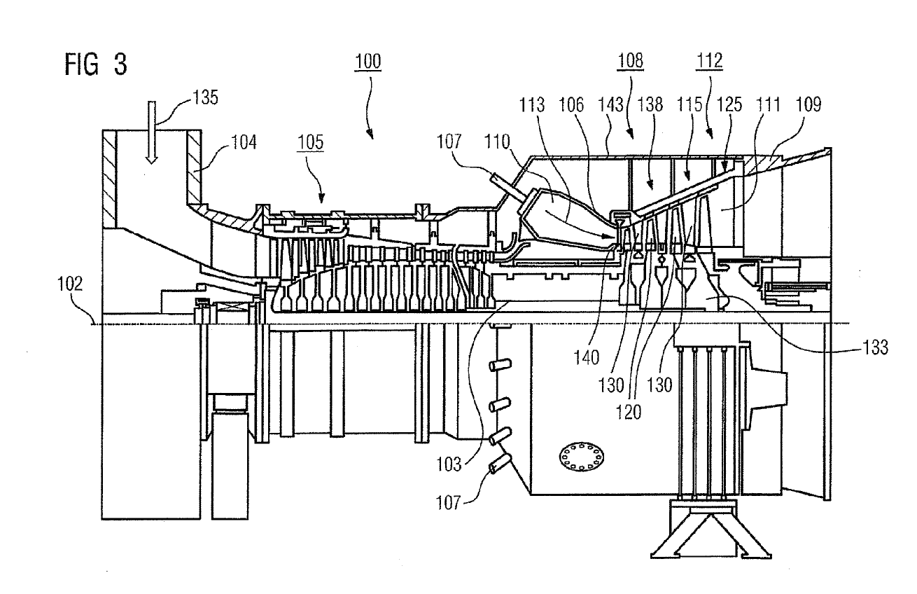

The welding appliance 33 may be arranged within (FIG. 1) the process chamber 31 but also outside, as is possible for example with a laser, the laser beams of which can be radiated into the process chamber 31 through a window 36 in the process chamber 31 (FIG. 2). In this case, the process chamber 31 can be moved together with the component 120, 130 in relation to the laser 33, in order to change the position or in order to guide the laser beam over the component 120, 130. In other welding processes in which plasma is used, this is not possible.

The self-contained system with the process chamber makes it possible to determine the oxygen content and the temperature of the melt of the welded part more accurately, since external influences are thereby minimized and a vacuum generally also reduces the retention of heat when the component is being preheated.

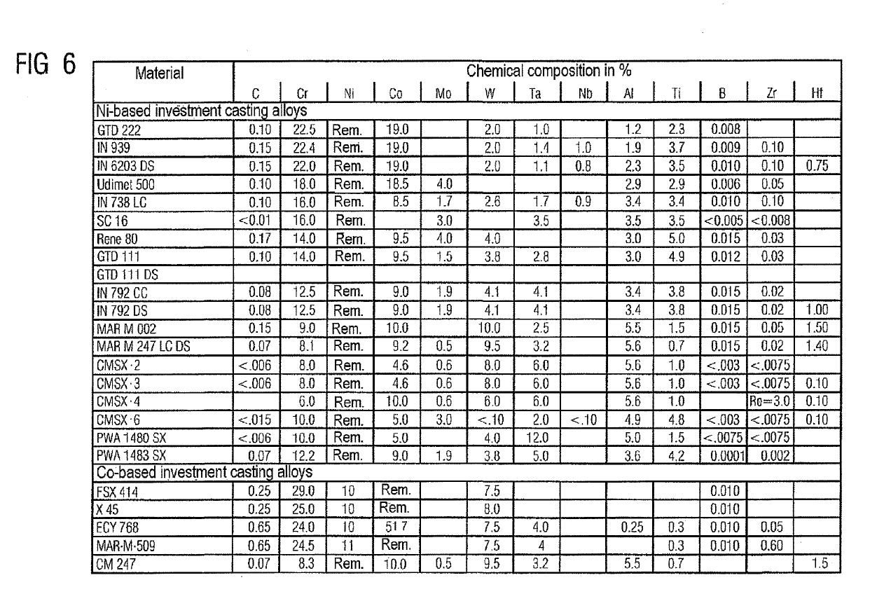

The component preferably has a superalloy according to FIG. 6.

FIG. 3 shows, by way of example, a partial longitudinal section through a gas turbine 100. In the interior, the gas turbine 100 has a rotor 103 with a shaft which is mounted such that it can rotate about an axis of rotation 102 and is also referred to as the turbine rotor. An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103. The annular combustion chamber 110 is in communication with a, for example, annular hot-gas passage 111, where, by way of example, four successive turbine stages 112 form the turbine 108. Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133. A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloys.

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

FIG. 4 shows a perspective view of a rotor blade 120 or guide vane 130 of a turbomachine, which extends along a longitudinal axis 121. The turbomachine may be a gas turbine of an aircraft or of a power plant for generating electricity, a steam turbine or a compressor. The blade or vane 120, 130 has, in succession along the longitudinal axis 121, a securing region 400, an adjoining blade or vane platform 403 and a main blade or vane part 406 and a blade or vane tip 415. As a guide vane 130, the vane 130 may have a further platform (not shown) at its vane tip 415. A blade or vane root 183, which is used to secure the rotor blades 120, 130 to a shaft or a disk (not shown), is formed in the securing region 400. The blade or vane root 183 is designed, for example, in hammerhead form. Other configurations, such as a fir-tree or dovetail root, are possible. The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloy.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally. In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1; these documents form part of the disclosure with regard to the solidification process.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1, which are intended to form part of this disclosure with regard to the chemical composition of the alloy.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

The blade or vane 120, 130 may be hollow or solid in form. If the blade or vane 120, 130 is to be cooled, it is hollow and may also have film-cooling holes 418 (indicated by dashed lines).

FIG. 5 shows a combustion chamber 110 of the gas turbine 100. The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1, which are intended to faun part of this disclosure with regard to the chemical composition of the alloy.

It is also possible for a, for example, ceramic theinial barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks.

Refurbishment means that after they have been used, protective layers may have to be removed from turbine blades or vanes 120, 130 or heat shield elements 155 (e.g. by sand-blasting). Then, the corrosion and/or oxidation layers and products are removed. If appropriate, cracks in the turbine blade or vane 120, 130 or in the heat shield element 155 are also repaired. This is followed by recoating of the turbine blades or vanes 120, 130 or heat shield elements 155, after which the turbine blades or vanes 120, 130 or the heat shield elements 155 can be reused.

1.-18. (canceled)

19. A device for welding a component, comprising:
a chamber, the component being arranged and welded in the chamber; and
a welding appliance, wherein the welding appliance is arranged outside the chamber.

20. The device as claimed in claim 19,
wherein the chamber includes a movement unit for moving the component, the movement unit being able to tilt the component away from or toward the welding appliance.

21. The device as claimed in claim 19,
wherein the chamber includes a movement unit for moving the component, the movement unit being able to rotate the component.

22. The device as claimed in claim 19,
wherein the chamber includes a movement unit for moving the component, the movement unit being able to displace the component vertically within the chamber.

23. The device as claimed in claim 19, further comprising:
a heating loop arranged around the component.

24. The device as claimed in claim 19, wherein the welding appliance is a laser.

25. The device as claimed in claim 19, wherein the chamber is a vacuum chamber.

26. The device as claimed in claim 19, wherein a protective gas is used in the chamber.

27. The device as claimed in claim 19, wherein the movement unit is a pivoting apparatus which tilts the component.

28. A method for welding a component, comprising:
providing a chamber, a welding appliance and a component;
arranging the component in the chamber; and
welding the component in the chamber by the welding appliance, wherein the welding appliance is arranged outside the chamber.

29. The method as claimed in claim 28, further comprising:
tilting the component during the welding.

30. The method as claimed in claim 28, further comprising:
preheating the component by a heating loop.

31. The method as claimed in claim 30, wherein a preheating temperature of the component is measured and controlled.

32. The method as claimed in claim 28, wherein the welding appliance is a laser.

33. The method as claimed in claim 32, wherein the chamber is moved together with the component in relation to the laser being arranged outside the chamber.

34. The method as claimed in claim 28, further comprising:
producing a vacuum in the chamber.

35. The method as claimed in claim 28, further comprising:
using a protective gas in the chamber.
